(19) United States
(12) Patent Application Publication
(10) Pub. No.: US 2013/0077435 A1
(43) Pub. Date: Mar. 28, 2013

(54) METHODS AND APPARATUS FOR STREAMER POSITIONING DURING MARINE SEISMIC EXPLORATION

(71) Applicant: Troy McKEY, III, La Place, LA (US)

(72) Inventor: Troy McKEY, III, La Place, LA (US)

(21) Appl. No.: 13/247,862

(22) Filed: Sep. 28, 2011

(51) Int. Cl. G01V 1/38

(52) U.S. Cl. 367/16; 367/19

(57) ABSTRACT

Disclosed are apparatus and methods for streamer positioning during marine seismic exploration. In one embodiment, a designated location for each of one or more transponders is determined based on a survey area, and each transponder is anchored to a sea floor at its own designated location. A marine seismic survey is then performed over the survey area with a marine-towed seismic sensor array, where multiple transceivers are moved along with the seismic sensor array during the marine seismic survey. Signals are communicated between the plurality of transceivers and each transponder so as to determine positions of the plurality of transceivers. Other embodiments, aspects, and features are also disclosed.

### BACKGROUND

In the oil and gas industry, geophysical prospecting is commonly used to aid in the search for and evaluation of subterranean formations. Geophysical prospecting techniques yield knowledge of the subsurface structure of the earth, which is useful for finding and extracting valuable mineral resources, particularly hydrocarbon deposits such as oil and natural gas. One technique of geophysical prospecting is a seismic survey. In a marine seismic survey, the seismic signal will first travel downwardly through a body of water overlying the subsurface of the earth.

Seismic energy sources (active seismic sources) are generally used to generate the seismic signal. Conventional energy sources for marine seismic surveys include air guns, water guns, marine vibrators, and other devices for generating acoustic wave-forms. After the seismic signal propagates into the earth, it is at least partially reflected by subsurface seismic reflectors. Such seismic reflectors are typically interfaces between subterranean formations having different elastic properties, specifically wave velocity and rock density, which lead to differences in acoustic impedance at the interfaces.

The reflections may be detected by marine seismic sensors (also called receivers) in an overlying body of water or alternatively on the sea floor. Conventional types of marine seismic sensors include particle-velocity sensors (geophones), water-pressure sensors (hydrophones), and other types of sensors. The resulting seismic data may be recorded and processed to yield information relating to the geologic structure and properties of the subterranean formations and their potential hydrocarbon content.

### BRIEF DESCRIPTION OF THE DRAWINGS

FIG. 1 is a plan view of marine-towed streamers with periodically placed transceivers in accordance with an embodiment of the invention.

FIG. 2 is a schematic diagram of a streamer positioning system in accordance with an embodiment of the invention.

FIG. 3A depicts exemplary perimeter locations for multiple transponders in relation to an example survey area in accordance with an embodiment of the invention.

FIG. 3B depicts exemplary perimeter and interior locations for multiple transponders in relation to an example survey area in accordance with an embodiment of the invention.

FIG. 4 is a flow chart showing a method for streamer positioning during marine seismic exploration in accordance with an embodiment of the invention.

FIG. 5 is a flow chart showing a method of determining a position of a transceiver on a marine-towed streamer in accordance with an embodiment of the invention.

FIG. 6 is a flow chart showing a method of determining sensor positions on a marine-towed streamer in accordance with an embodiment of the invention.

FIG. 7 is a schematic diagram showing an example computer apparatus suitable for use in accordance with embodiments of the invention.

Note that the figures provided herewith are not necessarily to scale. They are provided for purposes of illustration to ease in the understanding of the presently-disclosed invention.

### DETAILED DESCRIPTION

Factors impacting the quality of marine seismic data include the accuracy and precision of location data for the marine seismic sensors. In the case where the sensors are towed on multiple streamers, a two-dimensional array of sensors moves over a large survey area. In addition, as the streamers are towed, sensors in the array may drift somewhat in position relative to the other sensors. This relative movement of the sensors may occur, for example, as the seismic vessel makes a change in direction or shifts in the sea currents.

A conventional streamer positioning system may include a global positioning system (GPS) receiver on the seismic vessel and on a tail buoy. In addition, compass units may be placed periodically along the length of each streamer. However, while the conventional system provides sensor location accuracy in the range of several meters, the system for streamer positioning disclosed herein may provide the capability to locate the sensors within a meter or less.

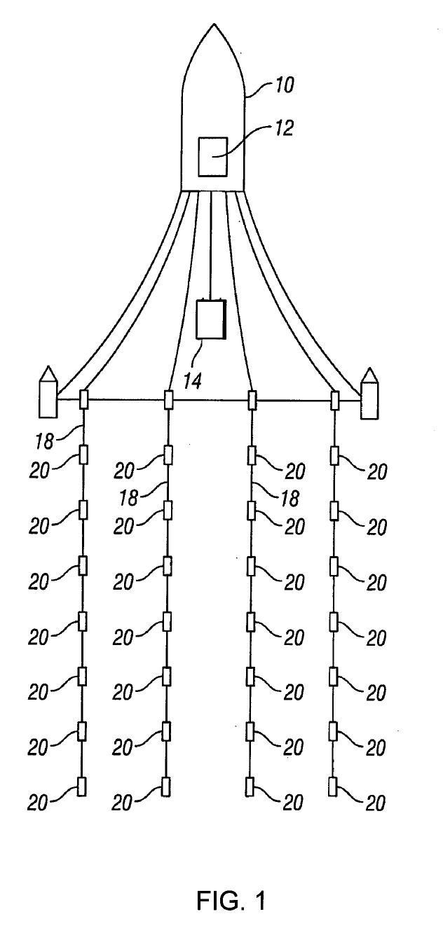

FIG. 1 is a plan view of marine-towed streamers 18 with periodically-placed positioning transceivers 20 in accordance with an embodiment of the invention. As shown in the plan view of FIG. 1, a seismic source 14 and a plurality of streamers 18 may be towed behind a seismic vessel 10. Each streamer 18 has periodically-placed seismic sensors (not illustrated) to record seismic wave-fields for purposes of seismic exploration. Of particular interest to the present patent application, each streamer 18 also includes periodically-placed positioning transceivers 20. While the seismic sensors record wave-field data, the positioning transceivers 20 are used to determine the positions of the seismic sensors as they are towed. A data processing unit 12 may be provided on the seismic vessel 10 for collecting, storing and processing the seismic wave-field data and the positioning-related data.

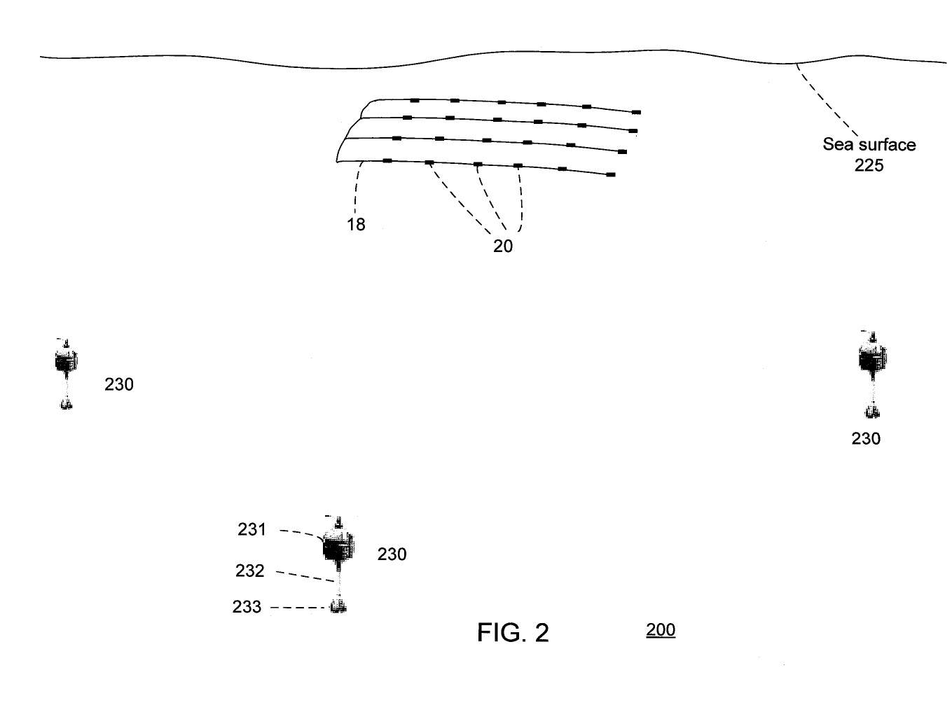

FIG. 2 is a schematic diagram of a streamer positioning system 200 in accordance with an embodiment of the invention. System 200 includes transceivers 20 on streamers 18 under a sea surface 225. In addition, system 200 includes at least one transponder 230. In one embodiment, system 200 includes at least three transponders 230.

In accordance with an embodiment of the invention, multiple transponders 230 may be anchored at different locations (and possibly different depths) on the sea floor. In an exemplary implementation, each transponder 230 may be configured as a buoyant unit 231 which floats above anchor 233, connected by a short tether 232.

The locations (including latitude, longitude, and depth information) of the transponders 230 may be determined with high accuracy, globally and/or relative to each other. Global positioning system (GPS) receivers on buoys floating above the transponders 230 on the sea surface may be used, for example, to determined locations globally. Acoustic signaling between the transponders 230 may be used to determine the locations of the transponders 230 relative to each other.

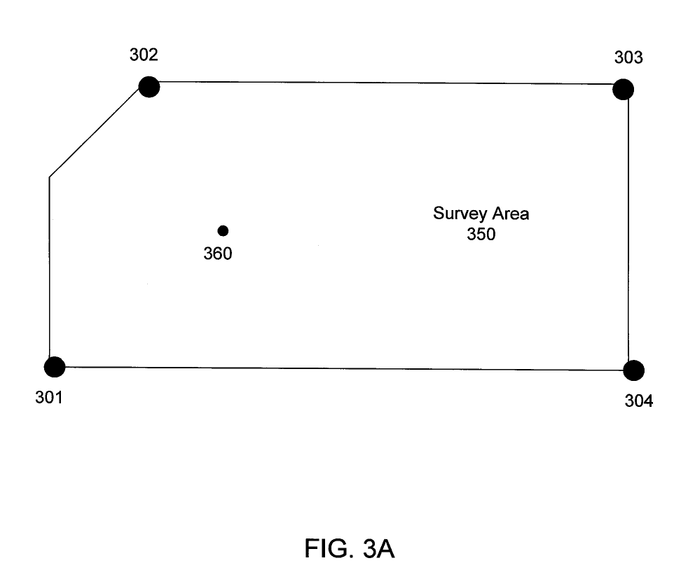

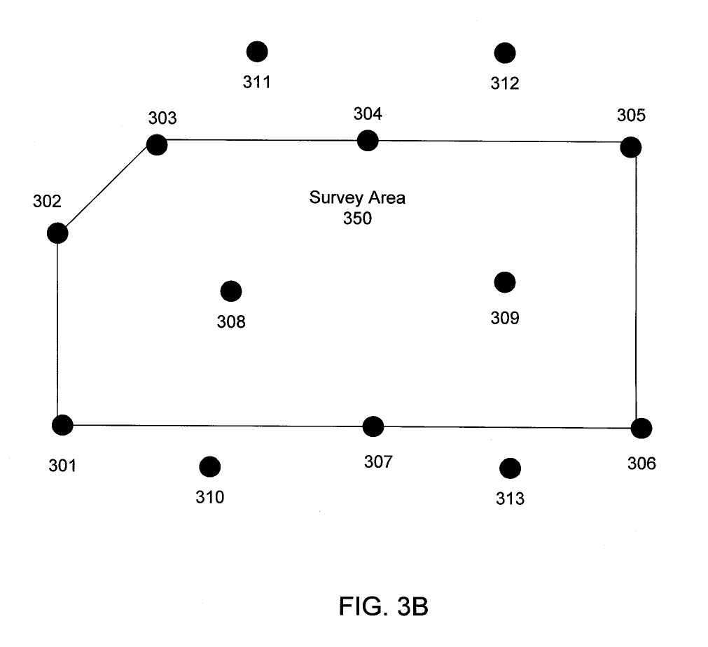

FIG. 3A depicts locations for multiple transponders in relation to an example survey area 350 in accordance with an embodiment of the invention. The example survey area 350 is shown as a polygon. More generally, however, the survey area may be of any shape. In this embodiment, the transponders may be located at separate locations (301, 302, 303 and 304) on a perimeter of the survey area 350. In this particular example, where the survey area 350 is in the shape of a polygon, the locations (301, 302, 303 and 304) may be on vertices of the polygon.

FIG. 3B depicts locations for multiple transponders in relation to an example survey area in accordance with another embodiment of the invention. In this embodiment, the transponders may be located at separate locations (301 through 307) on a perimeter of the survey area 350, at separate locations (308 and 309) in an interior of the survey area 350, and/or at separate locations (310 through 313) exterior to the survey area 350.

Locating the transponders at points spread out on the perimeter (for example, at the corners) of, and/or external to, the survey area 350 is advantageous in that it facilitates the accurate determination of positions (for example, position 360) within the survey area 350. This is due to the geometric considerations. Transponder locations internal to the survey area 350 may be advantageous in providing shorter signaling times between the transceivers 20 and the transponders 230.

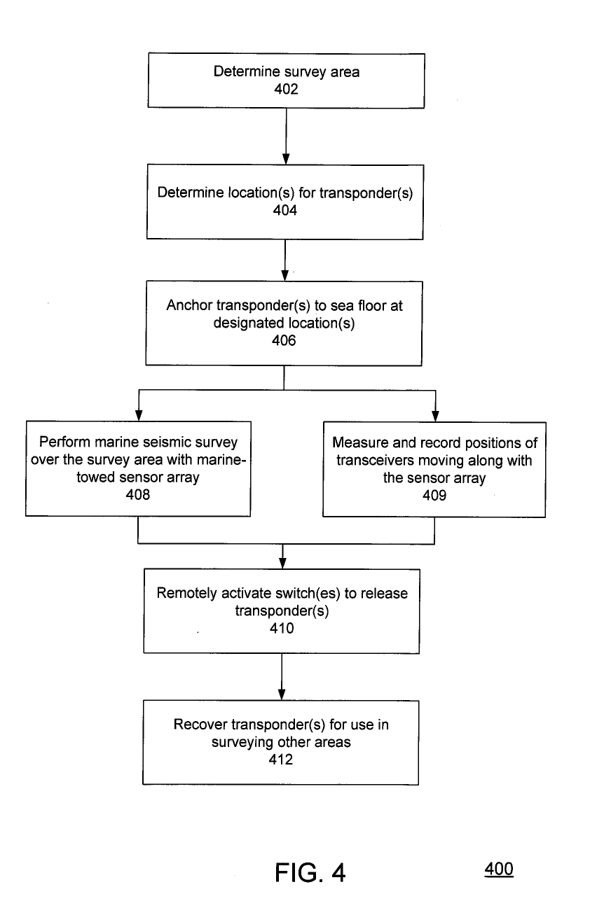

FIG. 4 is a flow chart showing a method 400 for streamer positioning during marine seismic exploration in accordance with an embodiment of the invention. Initially, a survey area is determined 402. The survey area may be the area of interest for marine seismic exploration to retrieve material properties and geological structure or for other purposes.

Based on the particularities of the survey area, the location(s) for the transponder(s) may then be determined (designated) 404. Example locations for multiple transponders with respect to an example survey area 350 are discussed above in relation to FIGS. 3A and 3B. The transponder(s) may then be anchored 406 to the sea floor at the designated transponder location(s). This may be done in advance of the actual seismic survey.

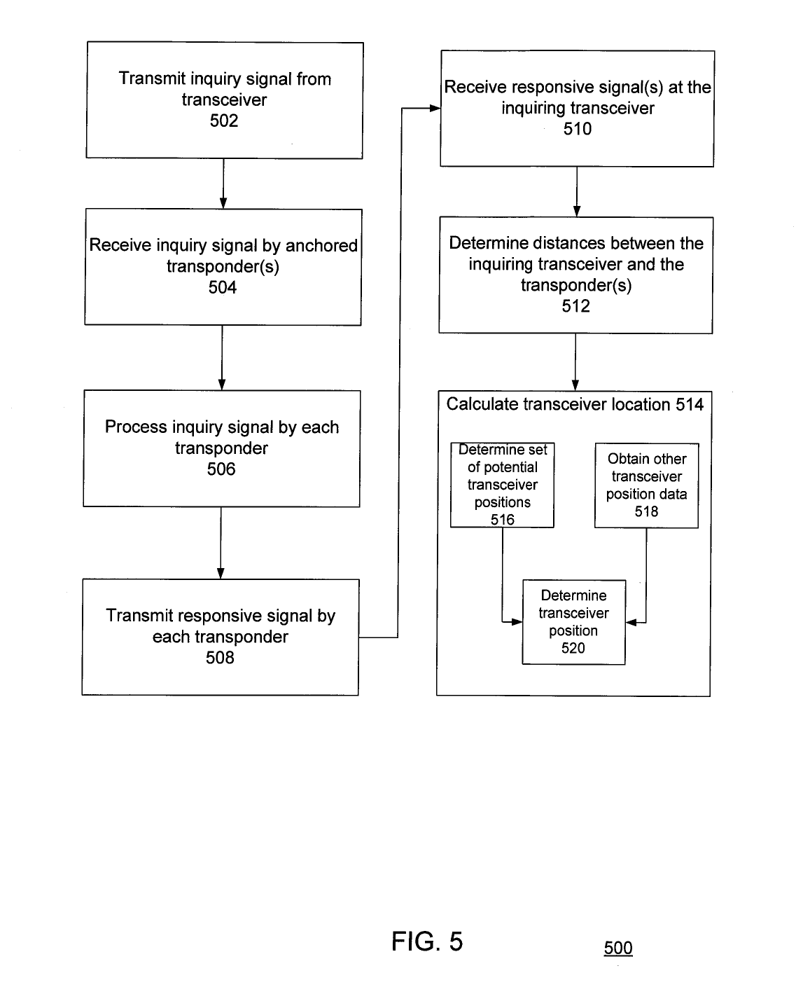

The marine seismic survey may then be performed 408 over the survey area with a marine-towed sensor array. While the marine seismic survey is being performed 408, the positions of transceivers 20 moving along with the sensor array may be measured and recorded 409. For example, the transceivers 20 may be arranged at periodically-spaced positions on each streamer, as described above. In one embodiment, the measurement of the position of a transceiver 20 may be accomplished by way of the method 500 described below in relation to FIG. 5.

After the seismic survey is complete for the survey area, it may be desired to retrieve the transponder(s) for re-use. If so, in accordance with an embodiment of the invention, switches may be remotely activated 410 to release (un-tether) the bouyant transponder unit(s) 331 from the anchor(s) 333. The transponder unit(s) 331 may then be recovered 412 by a vessel such that they (it) may be re-used in surveying other areas.

FIG. 5 is a flow chart showing a method 500 of determining a position of a transceiver 20 on a marine-towed streamer 18 in accordance with an embodiment of the invention. This method 500 may be performed frequently during a seismic survey to obtain streamer positioning data.

As shown in FIG. 5, an inquiry signal may be transmitted 502 from the transceiver 20 and received 504 by at least one anchored transponder 230. Each receiving transponder 230 may process 506 the inquiry signal and transmit 508 a responsive signal. In accordance with an embodiment of the invention, the inquiry signal and the responsive signals may be acoustically-transmitted data signals.

The inquiring transceiver 20 receives 510 the responsive signals. Based on the responsive signals, a distance between the inquiring transceiver 20 and each responsive transponder 230 may be determined 512. For example, a round-trip time from the transmission of the inquiry signal to the reception of each responsive signal may be computed by apparatus at, or communicatively coupled to, the transceiver 230. The round-trip time may be adjusted by subtracting an approximate time for processing at the transceiver and the transponder. The distance may then be computed as the round-trip time multiplied by the speed of the underwater acoustic signals.

The transceiver position may then be calculated 514. The calculation 514 of the transceiver position may include determining 516 a set of potential transceiver positions from the distance data. This determination 516 may take into account other data in addition to the distance data. For example, an adjustment may be made based on velocities (speed and direction) of the transceivers 20.

In some embodiments, other transceiver position data may be obtained 518 using a non-acoustic positioning technology. This other transceiver position data may be used, for example, to determine 520 the transceiver position from the set of potential transceiver positions.

In general, each measured distance between the inquiring transceiver 20 and a responsive transponder 230 defines a sphere centered on the known transponder location, where the radius of the sphere is the measured distance. Hence, with a single responding transponder 230, the location of the inquiring transceiver 20 may be determined to be somewhere on the sphere which has the measured distance as its radius and is centered on the known transponder location. In other words, a set of potential transceiver positions may be determined 516 from the distance data. In this case, the sphere defines the set of potential transceiver positions. If the depth of the transceiver is also known, then the set of potential transceiver positions may be narrowed to circle which is at the intersection of the sphere and a plane at the known depth.

With two responding transponders 230, the location of the inquiring transceiver 20 may be determined to be somewhere on a circle which is defined by the intersection between two spheres. Each sphere is centered at a known location of a responsive transponder 230 and has the distance between the transceiver 20 and the responsive transponder 230 as its radius. In this case, the circle defines the set of potential transceiver positions. If the depth of the transceiver is also known, then the set of potential transceiver positions may be narrowed to two points which are at the intersection of the circle and a plane at the known depth.

Knowledge of the set of potential transceiver positions may be used to refine a transceiver position which is obtained by other technological means. For example, if the location of the inquiring transceiver 20 is obtained by a global positioning system (GPS) device, the location may be refined by selecting a location point in the set of potential locations which is closest to the GPS-determined location.

With three responding transponders 230, the location of the inquiring transceiver 20 may be determined to be one of two points which is defined by the intersection between three spheres. Again, each sphere is centered at a known location of a responsive transponder 230 and has the distance between the transceiver 20 and the responsive transponder 230 as its radius. Selecting between the two potential locations may be accomplished using other data. In one example, if the depth of the transceiver is also known, then the depth information may be used to select between the two potential locations. In another example, location data obtained using a different technology, such as GPS, may be used to select between the two potential locations. In another example, a distance to a fourth responding transceiver 230 may be used to unambiguously determine the location of the inquiring transceiver 20.

The transceiver position calculation (step 514) may be performed by apparatus configured to make such computations. The apparatus may be embodied as hard-wired circuitry or as a processing system with instruction code configured to make the computations. The apparatus may be at, or communicatively coupled to, the inquiring transceiver 20. For example, the appratus may be at a computing system which is communicatively coupled by a data network to the various transceivers 20 in an array of streamers 18.

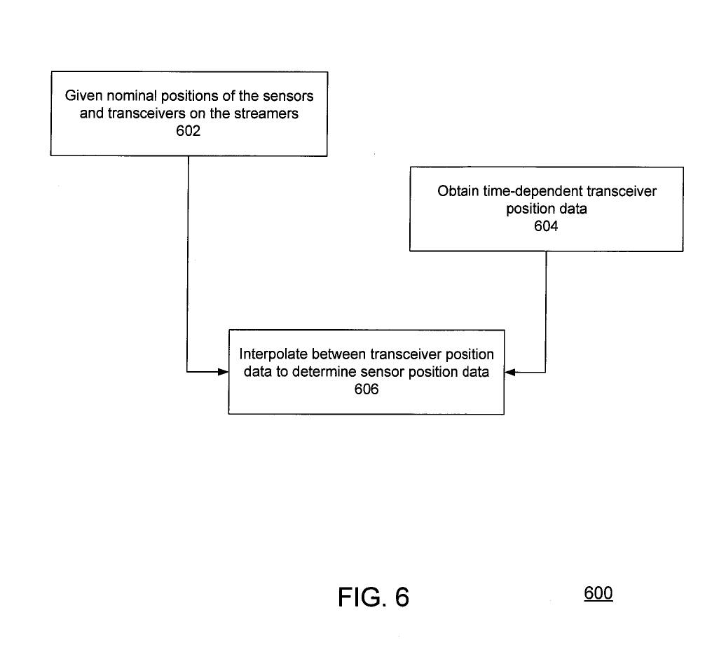

FIG. 6 is a flow chart showing a method 600 of determining sensor positions on a marine-towed streamer in accordance with an embodiment of the invention. In this method 600, the nominal positions of the sensors and transceivers on the streamers may be given or predetermined 602. The time-dependent transceiver position data is obtained 604, as measured, for example, using the method 500 described above in relation to FIG. 5. Interpolation 606 between the transceiver position data may then be performed to determine the sensor position data. The interpolation may be performed by circuitry configured to make such computations. The circuitry may be embodied as hard-wired circuitry or as a processing system with instruction code configured to make the computations.

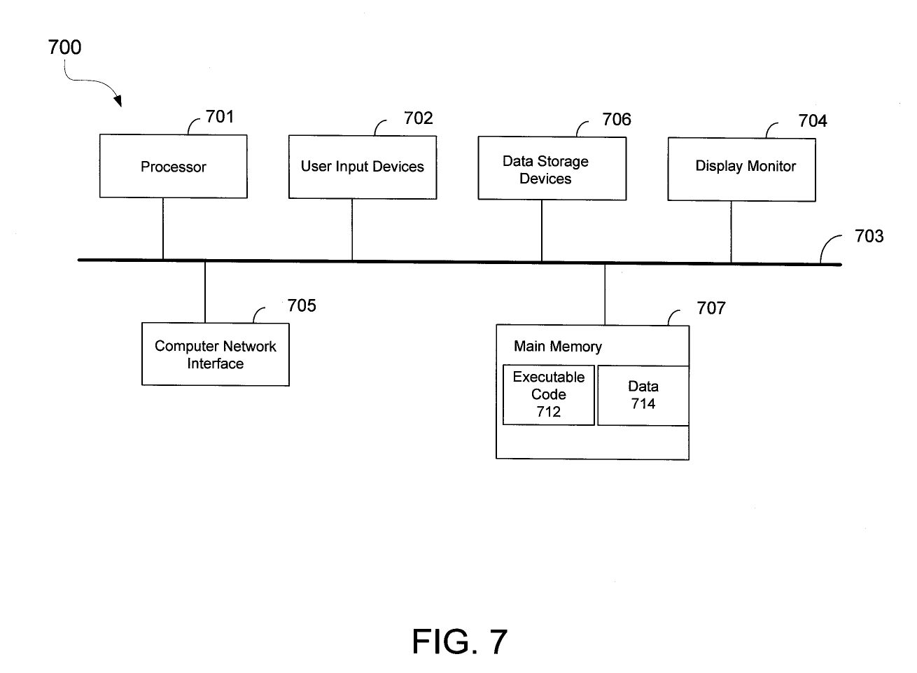

FIG. 7 is a schematic diagram showing a computer apparatus 700 in accordance with an embodiment of the invention. The computer apparatus 700 may be configured with executable instructions so as to perform the data processing methods described herein. The computer shown in the figure is just one simplified example of a computer which may be used to perform at least some of the processing steps described herein. Many other types of computers may also be employed, such as multi-processor computers. In addition, or alternatively, hard-wired circuitry may be configured to perform at least some of the processing steps described herein.

The computer apparatus 700 may include a processor 701, such as those from the Intel Corporation of Santa Clara, Calif., for example. The computer apparatus 700 may have one or more buses 703 communicatively interconnecting its various components. The computer apparatus 700 may include one or more user input devices 702 (e.g., keyboard, mouse), one or more data storage devices 706 (e.g., hard drive, optical disk, USB memory), a display monitor 704 (e.g., LCD, flat panel monitor, CRT), a computer network interface 705 (e.g., network adapter, modem), and a main memory 710 (e.g., RAM).

In this example, the main memory 710 includes executable code 712 and data 714. The executable code 712 may comprise computer-readable program code (i.e., software) components which may be loaded from computer readable storage medium 706, such as, for example, a hard disk drive or a solid state storage device, to the main memory 710 for execution by the processor 701. In particular, the executable code 712 may be configured to perform the data processing methods described herein.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A method for streamer positioning during marine seismic exploration, the method comprising:
determining a designated location for at least one transponder based on a survey area;
anchoring the at least one transponder to a sea floor at the designated location;
performing a marine seismic survey over the survey area with a towed seismic sensor array;
moving a plurality of transceivers along with the seismic sensor array during the marine seismic survey; and
communicating signals between the plurality of transceivers and the at least one transponder;
determining distances between the plurality of transceivers and the at least one transponder using the signals; and
determining positions of the plurality of transceivers using the distances.

2. The method of claim 1, wherein the signals are acoustic, and wherein communicating the signals comprises:
transmitting an inquiry signal from an inquiring transceiver;
receiving the inquiry signal by the at least one anchored transponder;
processing the inquiry signal by the at least one anchored transponder;
transmitting a responsive signal by the at least one anchored transponder; and
receiving the responsive signal at the inquiring transceiver.

3. The method of claim 2, further comprising:
using the distances to determine a set of potential positions for a transceiver.

4. The method of claim 3, further comprising:
obtaining other position data for the transceiver using a non-acoustic technology.

5. The method of claim 4, further comprising:
determining a position of the transceiver using both the set of potential positions and the other position data.

6. The method of claim 1, further comprising:
interpolating between the positions of the plurality of transceivers to determine positions of sensors in the marine-towed sensor array.

7. The method of claim 1, further comprising:
remotely activating switches of the at least one transponder to release a buoyant unit from an anchor; and
recovering the buoyant unit.

8. The method of claim 1, wherein the at least one transponder is located on a perimeter of the survey area.

9. The method of claim 1, wherein the at least one transponder is located external to the survey area.

10. The method of claim 1, wherein the at least one transponder is located internal to the survey area.

11. A system for streamer positioning during marine seismic exploration, the apparatus comprising:
at least one transponder configured to be anchored to a sea floor at a designated location; and
a plurality of transceivers positioned on streamers carrying an array of seismic sensors,
wherein the at least one transponder and the plurality of transceivers are configured to communicate signals and to determine positions of the plurality of transceivers, wherein the positions are time dependent.

12. The system of claim 11, wherein each transponder comprises a buoyant unit tethered to an anchor.

13. The system of claim 12, wherein each transponder further comprises a remotely-activated switch configured to release the buoyant unit from being tethered to the anchor.

14. The system of claim 11, wherein the signals are acoustic, and wherein each transceiver of the plurality of transceivers is configured to
transmit an inquiry signal to the at least one transponder, and
receive responsive signals from the at least one transponder.

15. The system of claim 14, wherein each transponder is configured to
receive inquiry signals from the plurality of transceivers, and
transmit responsive signals to the plurality of transceivers.

16. The system of claim 15, further comprising apparatus configured to
determine distances between the plurality of transceivers and the at least one transponder, wherein the distances are time dependent, and
determine the positions of the plurality of transceivers using the distances.

17. The system of claim 16, wherein the apparatus is further configured to:
determine a set of potential positions for a transceiver using the distances.

18. The system of claim 17, wherein the apparatus is further configured to:
obtain other position data for the transceiver using a non-acoustic technology.

19. The system of claim 18, wherein the apparatus is further configured to:
determine a position of the transceiver using both the set of potential positions and the other position data.

20. The system of claim 16, wherein the apparatus comprises at least one microprocessor, and memory for storing computer-readable code and data.

21. The system of claim 16, wherein the apparatus is further configured to
interpolate between the time-dependent positions of the plurality of transceivers to determine time-dependent positions of the seismic sensors.

22. An apparatus comprising:
a data storage system configured to store computer-readable program code and data;
a processor configured to access the memory and execute computer-readable program code;
computer-readable program code configured to determine distances between a plurality of transceivers and at least one transponder, wherein the distances are time dependent, and
computer-readable program code configured to determine positions of the plurality of transceivers using the distances, wherein the positions are time dependent.

23. The apparatus of claim 22, further comprising:
computer-readable program code configured to determine a set of potential positions for a transceiver using the distances.

24. The apparatus of claim 23, further comprising:
computer-readable program code configured to obtain other position data for the transceiver using a non-acoustic technology; and
computer-readable program code configured to determine a position of the transceiver using both the set of potential positions and the other position data.
